(19) United States
(12) Patent Application Publication
(10) Pub. No.: US 2015/0258960 A1
(43) Pub. Date: Sep. 17, 2015

(54) DEVICE COMPRISING A GAS GENERATOR TO PRODUCE A FLOW OF COMPRESSED GAS

(71) Applicant: Joachim Haase, Hannover (DE)

(72) Inventor: Joachim Haase, Hannover (DE)

(21) Appl. No.: 14/658,366

(22) Filed: Mar. 16, 2015

(30) Foreign Application Priority Data
Mar. 17, 2014 (DE) 10 2014 103 629.8

(51) Int. Cl. B60R 21/264; C06D 5/00

(52) U.S. Cl. CPC B60R 21/264; C06D 5/00

(57) ABSTRACT

A device is provided, designed as a jet pump, and having a gas generator to generate a flow of compressed gas, wherein the gas generator is equipped with a pyrotechnic propellant charge designed as a cutting or shaped charge. This pyrotechnic propellant charge can serve to generate a shock wave, as a flow of compressed gas, from the combustion gases of the propellant charge. The device is equipped with an inlet port of an inlet duct, which inlet port is arranged in the region of the smallest cross section of a venturi nozzle, such that surrounding air is sucked in through an exhaust port of the inlet duct as a result of the suction that arises. This difference in pressure can be used for various purposes.

### CROSS-REFERENCE TO RELATED APPLICATIONS

Priority is claimed to German Patent Application No. DE 10 2014 103 629.8, filed on Mar. 17, 2014, the entire disclosure of which is incorporated by reference herein.

### FIELD

The invention relates to a device, in particular designed as a jet pump.

### BACKGROUND

In U.S. Pat. No. 3,847,411 A, a device is described, which generates negative pressure in a passenger compartment by means of a pyrotechnic gas generator when an airbag is triggered such that a shock wave generated by the triggered airbag does not pose a danger to an occupant. For this purpose, the device has an airbag in which a propellant charge is used in conjunction with a venturi nozzle to generate the pressure. An inlet duct has at least one inlet port arranged in the region of the venturi nozzle as well as at least one exhaust port, which is arranged in a sealed housing.

A device is known from DE 32 12 303 A1, which already discloses the combination of a chemical propellant charge with a jet pump. The gas-generating chemical propellant charge is located pressed into a pressure-resistant capsule. The propellant charge should preferably degenerate fully and without residue with a large gas yield. In the nozzle antechamber pressure builds up as a result, the level of which results from both the amount of gas arising and the smallest cross section of the jet nozzle and can reach approximately 10 bar. The jet nozzle has the form of a de Laval nozzle. The gas jet issuing from the jet nozzle generates strong suction in the region of an outlet duct such that atmospheric air is sucked in via lateral inlet ducts. This air mixes in the tube with the gas jet from the propellant charge and together therewith forms the filling gas for an object of utility to be filled with the gas, for example an inflatable dinghy, which in turn is connected to the outlet port directly or by means of a tube connection. In terms of quantity, the volume of the air sucked in is a multiple of the volume of the gas released by the propellant charge.

EP 2 404 794 B1 relates to a device for emergency braking a vehicle comprising a brake plate which has negative pressure chambers that are connected to a vacuum pump and are open towards the carriageway. In order to build up sufficient negative pressure in the negative pressure chambers in a short space of time that is reasonable for emergency braking, the vacuum pump is designed as a jet pump, the jet pump being supplied with compressed gas by an ignitable propellant charge.

Furthermore, a collision protection device in a vehicle is known, for example from DE 40 18 348 A1, having an inflatable gas cushion, which device is equipped with a gas generator unit to generate the propellant charge gas for inflating the gas cushion. The gas generator unit has a pyrotechnic propellant charge with an ignition unit and is connected to a trigger sensor.

### SUMMARY

An aspect of the invention provides device, comprising: a gas generator including a pyrotechnic propellant charge; and a nozzle arrangement including a venture nozzle, an inlet duct, and an outlet duct, wherein a flow of compressed gas which can be generated using the pyrotechnic propellant charge can be introduced into the nozzle arrangement, wherein the inlet duct includes an inlet port, wherein the outlet duct includes an outlet port, wherein the inlet port is arranged in a region of the venturi nozzle, wherein the inlet port includes an exhaust port, the exhaust port being configured such that it can be positioned in a space, wherein the flow of the compressed gas can be modified with regard to at least one a compressed gas power and a compressed gas behavior over time according to one or more measured values registered by a pressure sensor, and wherein the exhaust port and the outlet port are arranged so as to be spatially separate.

### BRIEF DESCRIPTION OF THE DRAWINGS

The present invention will be described in even greater detail below based on the exemplary figure. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawing which illustrate the following:

FIG. 1 shows a schematic view of a device within the scope of the invention, having a gas generator equipped with a pyrotechnic propellant charge.

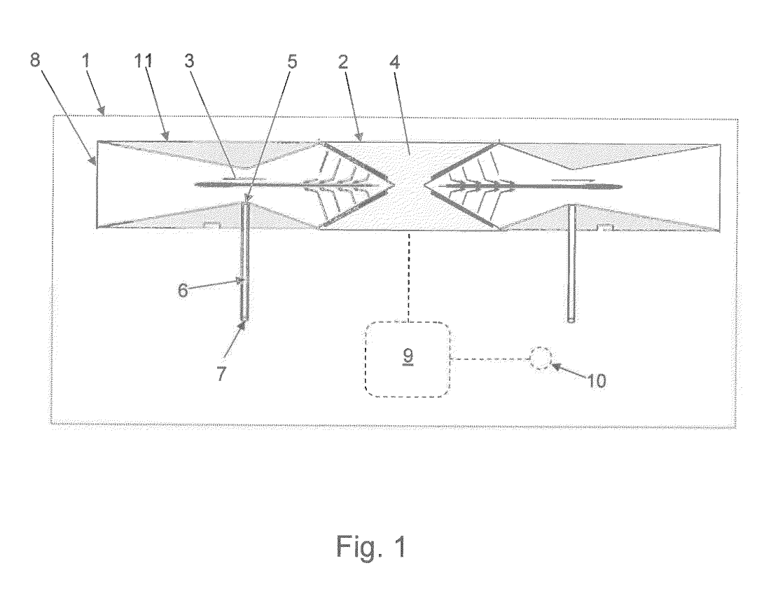

### DETAILED DESCRIPTION

An aspect of the invention is to produce a device designed as a jet pump for use in spaces, the generated flow of compressed gas being modifiable according to requirements.

An aspect of the invention provides to a device, in particular designed as a jet pump, comprising a gas generator having a pyrotechnic propellant charge, a flow of compressed gas that can be generated by means of the pyrotechnic propellant charge being introducible into a nozzle arrangement equipped with a venturi nozzle in order to generate excess pressure suddenly, and the device having an inlet duct having at least one inlet port and an outlet duct having at least one outlet port, such that as a result of the negative pressure arising in the venturi nozzle a fluid can be sucked in by means of the inlet duct and can be transported to the outlet port together with the flow of gas.

In an aspect of the invention, the flow of compressed gas that can be generated by means of the propellant charge is modifiable at least with regard to its power or its behavior over time according to measured values registered by a pressure sensor, the exhaust port and the outlet port being arranged so as to be spatially separate, in separate spaces. As a result of this, interference of the registered explosive shock wave and the negative pressure wave generated by the propellant charge can be generated, with the consequence of total cancellation in an ideal situation. In particular, in the process the negative pressure generated is prevented from having a disadvantageous effect in an undesirable manner within the space in which the exhaust port is located. By arranging the exhaust port and the outlet port so as to be spatially separate, in particular in separate spaces, the flow of compressed gas can also be discharged across comparatively long distances from the origin of the shock wave. In particular, a risk to persons can be reliably ruled out in this way. As a result of this, the capability is created for the first time of using an exhaust flow generated according to the flow of compressed gas that is formed explosively. For this purpose, the inlet duct, which can of course be extended by a line according to the respective intended purposes, can be positioned with its exhaust port in a space to be evacuated.

An aspect of the invention is thus based on the knowledge that an exhaust flow can be generated suddenly by the device according to the invention by means of the propellant charge, as a result of which exhaust flow a negative pressure can be, likewise suddenly, generated and this can be used for a wide range of extremely diverse tasks. For example, a relief of pressure in vehicles, in particular aircraft, ships, trains or any other land, air or water vehicles can be achieved in order to thus counteract the propagation of a shock wave or at least to reduce its effects to the extent that a risk to persons can be prevented.

Although the possible intended purposes cannot be listed conclusively due to their scope, two preferred fields of application do nevertheless emerge. Firstly, the negative pressure wave can be used in a targeted manner to destroy the structure of the space by means of an implosion. In this way, for example, buildings can be caused to collapse without the risk of an explosion where objects being flung out could lead to a potential hazard for people and to damage of surrounding buildings. Secondly, the destructive effects of an explosion wave can be substantially reduced or even totally absorbed by the device according to the invention in that the explosion wave can be conducted away by the negative pressure flow through the inlet duct, the nozzle arrangement and the outlet duct. In the process, the outlet port can in particular lead to the open air in the surrounding area, such that the flow of compressed gas escaping there cannot give rise to any harmful effects. According to the principle according to the invention, in particular safety means for chemical or process plants, for gas grids or even in the mining industry can thus be achieved, as well as protective devices in front of explosive charges.

In the process, the effectiveness of the device according to the invention can be further improved in that the inlet port is arranged in the region of a smallest cross-sectional area of the venturi nozzle in order to thus achieve an optimum realization of the flow of compressed gas for extraction through the inlet duct. The venturi nozzle can, for example, also be constructed as a de Laval nozzle for this purpose.

The device can be operated and activated by means of a manual trigger of the propellant charge, it being possible to select a plurality of ignition phases or quantities of propellant charge. It is particularly practical especially with respect to safety means for the device to be equipped with a control unit and a pressure sensor. By means of the pressure sensor a sudden rise in pressure resulting from explosive pressure propagation can be reliably detected and a control command to trigger the propellant charge can be generated by means of the control unit. In the process, the power of the propellant charge quantity thus activated can be adjusted depending on the pressure difference registered by the pressure sensor.

A particularly practical embodiment of the invention is achieved in that the propellant charge is concave such that a flow of compressed gas that is concentric to an axis can be generated. As a result of this a detonation front is generated as a targeted shock wave in order to thus generate the flow of compressed gas in a particularly efficient manner. In particular, a defined effective direction is thus imposed on the flow of compressed gas due to the concave form of the propellant charge and as a result, a particularly efficient realization of the explosive expansion of the propellant charge in the desired flow of compressed gas is achieved.

According to a further advantageous embodiment, the propellant charge has an insert shaped in the manner of the surface of a cone and having a duct pointing forwards. The insert is surrounded by a volatile explosive, the explosive being compacted, for example pressed, into the form determined by the insert. A detonator is connected to the propellant charge. If the propellant charge is detonated then, starting from the tip of the insert shaped in the manner of the surface of a cone, a directional, in particular linear, shock wave forms, which is fed at a very fast flow rate into the nozzle arrangement. The generation of this directional shock wave is based on the effect that the detonation front propagates as a shock wave at supersonic speed when the shaped charge is detonated and the resultant force becomes effective in a manner packed into a line along an axis. In practice a cumulative jet thus forms.

It has already proven to be particularly practical in this connection if the device has a plurality of nozzle arrangements arranged on opposite sides of the propellant charge. As a result of the symmetrical structure thus achieved, the reaction forces arising during the detonation of the propellant charge and of the introduction into the nozzle arrangement cancel each other out overall, such that the device only requires low fixing forces in particular. Moreover, as a result, the device can be designed in a comparatively compact manner and, for example, also as a mobile, portable unit.

Furthermore, the device can also be integrated in a piece of personal protective equipment or protective clothing. For example, the device can constitute a component part of the personal protective equipment of explosive ordinance disposal personnel and be integrated in a rucksack or in a piece of leg or foot protection.

The invention allows for various embodiments. To better explain the basic principle of the invention, one embodiment is described in the following and is shown in the drawing, which is a schematic view of a device 1 comprising a gas generator 2 to generate a flow of compressed gas 3, the gas generator 2 being equipped with a pyrotechnic propellant charge 4, which is constructed as a cutting or shaped charge. This pyrotechnic propellant charge 4 serves to generate a shock wave as a flow of compressed gas 3 out of the combustion gases of the propellant charge 4. In accordance with the principle of the venturi nozzle that is known per se, a likewise sudden negative pressure is generated. For this purpose, the device 1 is equipped with an inlet port 5 of an inlet duct 6, which port is arranged in the region of the smallest cross section of a nozzle arrangement 11 accommodating the venturi nozzle, such that surrounding air is sucked in through an exhaust port 7 of the inlet duct 6 as a result of the suction that arises and is fed to an outlet port 8. This difference in pressure can be used for various purposes. For example, harmful shock waves, for example from explosions, can thus be compensated and therefore rendered harmless. For this purpose, the device 1 is equipped with a control unit 9 and a pressure sensor 10 to register differences in pressure. A symmetrical structure, which is largely free from external forces during operation, is achieved by the device 1 having two nozzle arrangements 11 arranged on opposite sides of the propellant charge 4.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A device, comprising:
a gas generator including a pyrotechnic propellant charge; and
a nozzle arrangement including a venture nozzle, an inlet duct, and an outlet duct,
wherein a flow of compressed gas which can be generated using the pyrotechnic propellant charge can be introduced into the nozzle arrangement,
wherein the inlet duct includes an inlet port,
wherein the outlet duct includes an outlet port,
wherein the inlet port is arranged in a region of the venturi nozzle,
wherein the inlet port includes an exhaust port, the exhaust port being configured such that it can be positioned in a space,
wherein the flow of the compressed gas can be modified with regard to at least one a compressed gas power and a compressed gas behavior over time according to one or more measured values registered by a pressure sensor, and
wherein the exhaust port and the outlet port are arranged so as to be spatially separate.

2. The device of claim 1, wherein the inlet port is arranged in a region of a smallest cross-sectional area of the venturi nozzle.

3. The device of claim 1, further comprising:
a control unit; and
the pressure sensor.

4. The device of claim 1, wherein the propellant charge is concave such that the flow of gas concentric to an axis can be generated.

5. The device of claim 1, wherein the propellant charge includes an insert, the insert being shaped in a manner of a surface of a cone.

6. The device of claim 1, wherein the propellant charge has a cutting charge.

7. The device of claim 1, wherein the propellant charge has a shaped charge.

8. The device of claim 1, comprising:
a plurality of nozzle arrangements arranged on opposite sides of the propellant charge.

9. The device of claim 1, configured to be a component part of a mobile, portable piece of equipment.

10. The device of claim 1, configured to be a component part of personal protective equipment for a task force.

11. The device of claim 1, configured such that surrounding air is sucked in through the exhaust port of the inlet duct as a result of suction that arises.
